(19) United States
(12) Patent Application Publication
(10) Pub. No.: US 2008/0225806 A1
(43) Pub. Date: Sep. 18, 2008

(54) SYSTEM AND METHOD FOR ENABLING MOBILITY IN INTERNET PROTOCOL NETWORKS

(75) Inventors: Yair Arian, Pardesia (IL); Raviv Zeev, Hod Hasharon (IL)

Correspondence Address: FOGG & POWERS LLC, 10 SOUTH FIFTH STREET, SUITE 1000, MINNEAPOLIS, MN, 55402, US

(73) Assignee: ADC Telecommunication Israel Ltd., Herzliya (IL)

(21) Appl. No.: 11/686,604

(22) Filed: Mar. 15, 2007

(51) Int. Cl. H04Q 7/24

(52) U.S. Cl. 370/338

(57) ABSTRACT

A method to enable mobility while connected to an Internet protocol network comprises receiving a first data packet from a mobile node at a first mobile gateway in a mobile-gateway-communication network via a first access point and determining if a communication session is ongoing responsive to receiving the first data packet. When it is determined that a communication session is not ongoing, the first mobile gateway is established as a home mobile gateway for the duration of the communication session. When the mobile node connects to a second mobile gateway in the mobile-gateway-communication network via a second access point during the communication session, a tunnel is opened from the second mobile gateway to the home mobile gateway so that the communication session is maintained regardless of the protocol implemented by the mobile node and the access points.

### BACKGROUND

Municipal wireless mesh networks permit users with WiFi enabled devices to move around the municipality while connected to the Internet. Internet protocol (IP) networks have difficulty routing the IP data packets when the attachment point of a mobile node to the network is constantly changing. In some systems, upstream routers route the downstream data packets (from the network to the user) on static routes. In other systems, a routing protocol, such as open shortest path first (OSPF), advertises the IP address of every new user attaching to an access router. When there are many users moving around, attaching and detaching from access points in the public network, host specific routes propagate throughout the Internet protocol (IP) network overloading routers with host specific routes.

To prevent the frequent advertisement of host routes, the Internet Engineering Task Force (IETF) established a Mobile IP solution that is described in the RFC-3344 standard. The Mobile IP solution identifies the mobile node by its home IP address to transparently routes IP packets between the mobile node and the Internet. The router served by the home IP address is always the home router (also referred to herein as the “home agent”) regardless of the location of the mobile node. Any other access router serves as a foreign or remote agent to the home router when the mobile node connects to the other access router. Specifically, when the mobile node connects to a remote agent, the remote agent informs the home agent of the point of attachment of the mobile node using the Mobile IP protocol and a care-of address. The home agent opens an IP tunnel to the care-of address and sends IP packets destined to the mobile node through the tunnel. The remote agent at the end of tunnel delivers the packets to the mobile node via the tunnel opened by the home agent.

This mobile IP solution requires the installation of Mobile IP software on three entities in the network: the home agent, the remote agent, and the mobile node. In many cases the home agent, the remote agent, and the mobile node are provided by different vendors and do not implement the same software. If the network supports a proxy mobile IP client that acts as a mobile node client, the mobile node does not need to have the mobile IP software. However, the home agent and the remote agent still require the mobile IP software. In all cases, the Mobile IP solution requires that software be installed on several types of elements in the network (home agents, remote agents, and mobile nodes). It is unlikely that all the various communication system elements are supplied by the same vendor and able to support the software required to implement mobility without a standard protocol such as the Mobile IP solution.

The mobile IP solution routes packets from the home agent to the foreign agent, even if the source of the downstream packets is located in proximity to the mobile node and the home agent is located far from the source of the downstream packets. Thus, the data packets routed by the mobile IP solution are sometimes sent over a long-distance route even when a shorter local route is physically available.

To solve the inefficiency in Mobile IP when roaming between geographically contiguous subnets, the IETF has established the network-based localized mobility management (netlmm) working group. The netlmm protocol is a network protocol between an access router and a mobility anchor point router. This solution is hierarchical forcing all the downstream data traffic to go through the mobility anchor point router. It also limits the scope of the local mobility to the geographic area covered by the mobility anchor router. In the netlmm solution, the access router and the anchor point router are potentially provided by different vendors. The current draft for the netlmm protocol is applicable to IPv6 networks only.

### SUMMARY

In a first embodiment, a method to enable mobility while connected to an Internet protocol network comprises receiving a first data packet from a mobile node at a first mobile gateway in a mobile-gateway-communication network via a first access point and determining if a communication session is ongoing responsive to receiving the first data packet. When it is determined that a communication session is not ongoing, the first mobile gateway is established as a home mobile gateway for the duration of the communication session. When the mobile node connects to a second mobile gateway in the mobile-gateway-communication network via a second access point during the communication session, a tunnel is opened from the second mobile gateway to the home mobile gateway so that the communication session is maintained regardless of the protocol implemented by the mobile node and the access points.

In a second embodiment, a method to enable mobility while connected to an Internet protocol network comprises receiving a first data packet at a mobile gateway via a first access point implementing a first protocol. The data packet is sent from a mobile node. Responsive to receiving the first data packet, a search protocol is implemented to broadcast an inquiry over a mobile-gateway-communication network to determine that the mobile gateway is to be used a home mobile gateway or a visited mobile gateway. When the mobile gateway determines it is to be used as a visited mobile gateway, the mobile gateway opens a tunnel to the home mobile gateway via the mobile-gateway-communication network. The communication session is maintained regardless of the protocol implemented by the mobile node, and the home mobile gateway is used for the duration of the communication session. The visited mobile gateway is used for at least the duration of the communicative coupling between the first access point and the mobile node, and wherein.

In a third embodiment, a communication system comprises a plurality of mobile gateways forming a mobile-gateway-communication network, and a plurality of access points each communicatively coupled to one of the mobile gateways. Each mobile gateway is configured to implement a search protocol and a tunneling protocol. Each access point is configured to transmit and receive signals from mobile nodes implementing a first protocol. A mobile node that initiates a communication session with an Internet protocol network at a first location via a first access point and a first mobile gateway continuously maintains the communication session via the first mobile gateway while moving to a second location. A second mobile gateway in the mobile-gateway communication network is communicatively coupled to the mobile node via a second access point and the second mobile gateway opens a tunnel from the second mobile gateway to the first mobile gateway over the mobile-gateway-communication network to maintain the communication session with the mobile node and the first mobile gateway.

In a fourth embodiment, a method to enable mobility while connected to an Internet protocol network comprises receiving a first data packet at a mobile gateway via a first access point. The data packet is sent from a mobile node implementing a first protocol. Responsive to receiving the first data packet, an inquiry is sent over the mobile-gateway-communication network to determine the mobile gateway is to be used a home mobile gateway or a visited mobile gateway. When a response to the inquiry is not received from the other mobile gateways in the mobile-gateway-communication network, the mobile gateway is established as the home mobile gateway. When a response to the inquiry is received from one of the other mobile gateways in the mobile-gateway-communication network, the mobile gateway is established as the visited mobile gateway. The communication session is maintained regardless of the protocol implemented by the mobile node and the home mobile gateway is used for the duration of the communication session. The visited mobile gateway is used for at least the duration of the communicatively coupling between the first access point and the mobile node.

### DRAWINGS

FIG. 1 is a block diagram of a communication system including a mobile-gateway-communication network in accordance with the present invention.

FIG. 2 is a flow diagram of one embodiment of a method to enable mobility while connected to an Internet protocol network in accordance with the present invention.

FIG. 3 is a block diagram of a mobile-gateway-communication network communicatively coupled to a mobile node located at a first location in accordance with the present invention.

FIG. 4 is a block diagram of a mobile-gateway-communication network communicatively coupled to a mobile node located at a first interim location in accordance with the present invention.

FIG. 5 is a block diagram of a mobile-gateway-communication network communicatively coupled to a mobile node located at a second interim location in accordance with the present invention.

FIG. 6 is a block diagram of a mobile-gateway-communication network communicatively coupled to a mobile node located at a second location in accordance with the present invention.

FIG. 7 is a flow diagram of one embodiment of a method to enable mobility while connected to an Internet protocol network in accordance with the present invention.

FIGS. 8A-8C are flow diagrams of one embodiment of a method to enable mobility while connected to an Internet protocol network in accordance with the present invention.

FIG. 9 is a block diagram of a mobile-gateway-communication network communicatively coupled to a mobile node in accordance with the present invention.

FIG. 10 is a flow diagram of one embodiment of a method to enable mobility while connected to an Internet protocol network in accordance with the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

Embodiments of the present invention provide a mobile-gateway-communication network that communicatively couples a plurality of mobile gateways. In order to overcome the limitations of the prior art described above in the background, the home mobile gateway described herein is dynamic and not fixed in advance. The home mobile gateway is the mobile gateway that is most accessible (typically geographically closest) to user when the user connects to the mobile-gateway-communication network for a communication session. The mobile-gateway-communication network described herein can be a layer 2 network for the search protocol that extends up to hundreds of miles. Alternatively, the mobile-gateway-communication network can use IP table mappings, which have no practical geographic limit and only require a mapping configuration. In another implementation of this embodiment, the mobile-gateway-communication network described herein can be a layer 3 Internet protocol network, in which case the search protocol is not efficient over long distances.

The mobile-gateway-communication network enables communication across an independent cluster architecture network topology. With this architecture, the wireless access network between the mobile node and the access points is built from independent wireless clusters that do not communicate between each other and that may use different wireless technologies (layer 2 mesh, layer 3 mesh, bridge, router, etc.). In one implementation of this embodiment, at least one independent cluster includes several wireless cells. Each cluster transmits all the traffic external to the cluster to the mobile gateway, which handles authentication, service, routing, handoff, and accounting. This topology enables the use of wireless clusters consisting of different AP vendors, resulting in low deployment costs. Additionally, this topology reduces management costs since the clusters are configured identically, while authentication and services are provisioned from a central location for each user.

The mobile gateways in the mobile-gateway-communication network each have a common search protocol. The access points communicatively coupled to the mobile gateway and the mobile nodes communicating over the mobile-gateway-communication network are independent of any special protocol or software.

When a mobile node first connects to the IP network, the mobile gateway to receive the first data packet for the communication session becomes the home mobile gateway for the duration of the communication session. All data packets in that communication session are routed between the source of data packets in the Internet and the mobile node through the home mobile gateway. When the mobile node changes locations and connects with an access point that is communicatively coupled to second mobile gateway, the second mobile gateway opens a tunnel to the home mobile gateway to seamlessly continue the communication session. As the mobile node roams, the communication session is maintained regardless of the protocol implemented by the access points, the mobile node, and the communication networks between the mobile node and the access point. For example, IP mobility is maintained between a worldwide interoperability for microwave access (WiMAX) network at one mobile gateway and a wireless local area network (WLAN) at another mobile gateway. Likewise, IP mobility is maintained between wireless networks and wireline networks.

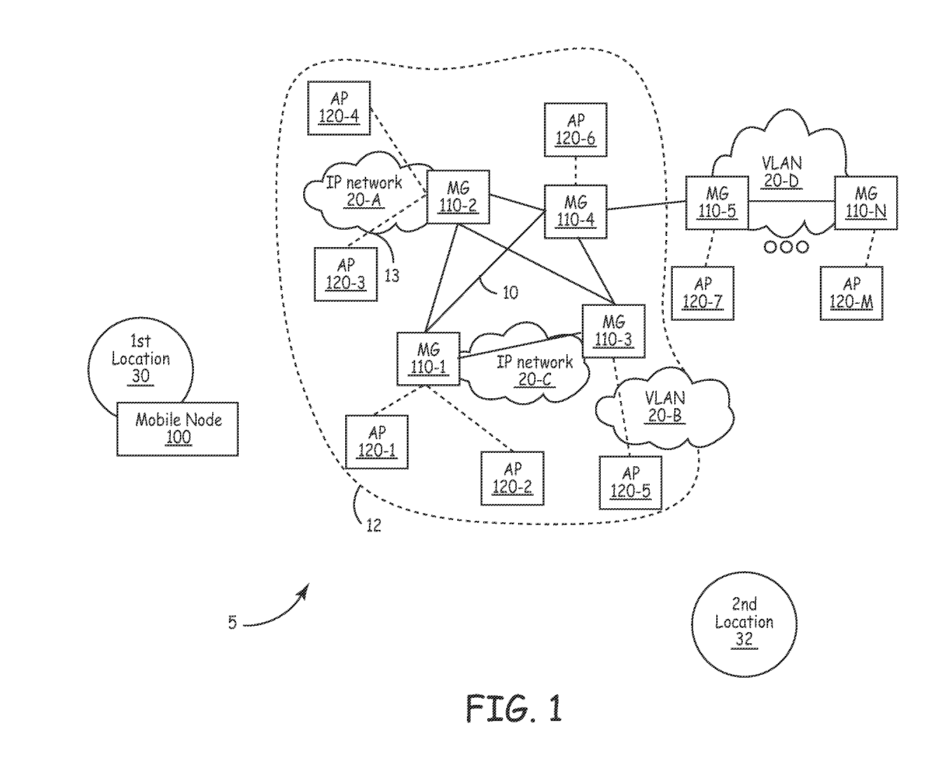

FIG. 1 is a block diagram of a communication system 5 including a mobile-gateway-communication network in accordance with the present invention. The communication system 5 includes a plurality of mobile gateways (MG) 110 (1-N) that form the mobile-gateway-communication network. The communication system 5 also includes a plurality of access points (AP) 120 (1-M) that are each configured to transmit and receive signals from mobile nodes 100 implementing at least one protocol. The communication links connecting mobile gateways 110 to each other are shown as solid lines. The mobile-gateway-communication network is represented generally by the numeral 10, which labels the solid line between the mobile gateway 110-1 and mobile gateway 110-4. The communication between the communicatively coupled mobile gateways 110 (1-N) in the mobile-gateway-communication network 10 is established over logical links comprising either an IP network represented generally by the numeral 20-C, and/or a shared medium type network like a virtual local area network (VLAN) represented generally by the numeral 20-D. As defined herein, VLAN is a layer 2 network and includes VLAN, multi protocol label switching (MPLS), virtual private LAN service (VPLS), and asynchronous transfer mode (ATM), and other layer 2 network protocols. Each mobile gateway 110 is configured to implement a search protocol and a tunneling protocol as described below.

In one implementation of this embodiment, the mobile-gateway-communication network 10 implements the search protocol over the VLAN 20-D. In this case, one mobile gateway, for example mobile gateway 110-N, broadcasts on the medium. The other mobile gateways, for example mobile gateway 110 (1-5), each check if it has the session. The VLAN 20-D is a point to multipoint communication (or a multipoint to multipoint communication link) using a broadcast shared medium channel or link.

In another implementation of this embodiment, the mobile-gateway-communication network 10 implements the tunneling protocol between the mobile gateways over an IP network 20-C that tunnels IP packets. In an exemplary case, the mobile-gateway-communication network 10 comprises VLANs 20-D on which the search protocol is implemented and IP networks 20-C on which the tunneling protocol is implemented. In yet another implementation of this embodiment, the mobile-gateway-communication network 10 comprises IP networks 20-C on which the search protocol and tunneling protocol are both implemented.

Transport network links are shown as dashed lines connecting an access point 120 to one of the mobile gateways 110 (1-N). The transport network is represented generally by the numeral 13, which labels the dashed line between the access point 120-3 and the mobile gateways 110-2. The transport network 13 is separate from the mobile-gateway-communication network 10. The communication between the communicatively coupled mobile gateways 110 (1-N) and access points 120 (1-M) is established over logical links comprising either an IP network represented generally by the numeral 20-A, and/or a shared medium type network like a virtual local area network (VLAN) represented generally by the numeral 20-B.

In one implementation of this embodiment, the transport network includes at least one IP network 20-A. In another implementation of this embodiment, the transport network includes at least one layer 2 network, such as a VLAN 20-B. In this case, the VLAN 20-B in the transport network 13 is for moving traffic from the access points 120 (1-M) to the mobile gateways 110 (1-N), while the VLAN 20-D in the mobile-gateway-communication network 10 is for searching.

The mobile node 100 uses a radio frequency access network (not shown in FIG. 1) to access an accessible access point 120 in the communication system 5. In some cases, the access network, the transport network 13 and the one or two types of logical networks that comprise the mobile-gateway-communication network 10 are owned by different operators.

The mobile-gateway-communication network 10 can be implemented in metropolitan areas, rural areas, or on campuses, such as university or company campuses. In one implementation of this embodiment, the search methods are the search methods used in peer-to-peer networks although search latency is critical.

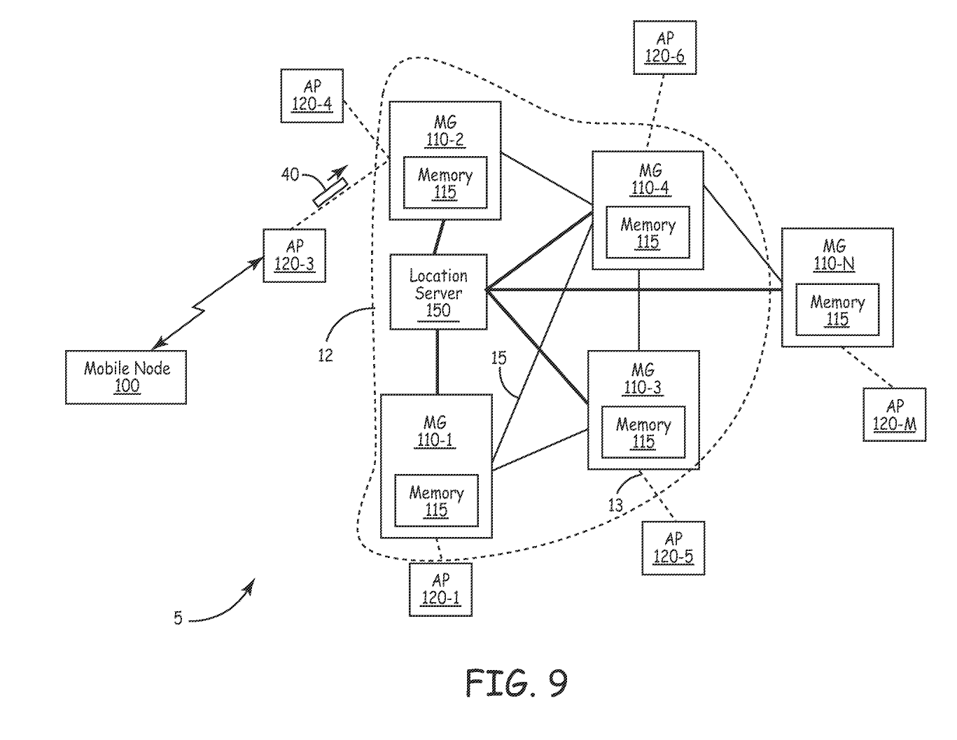

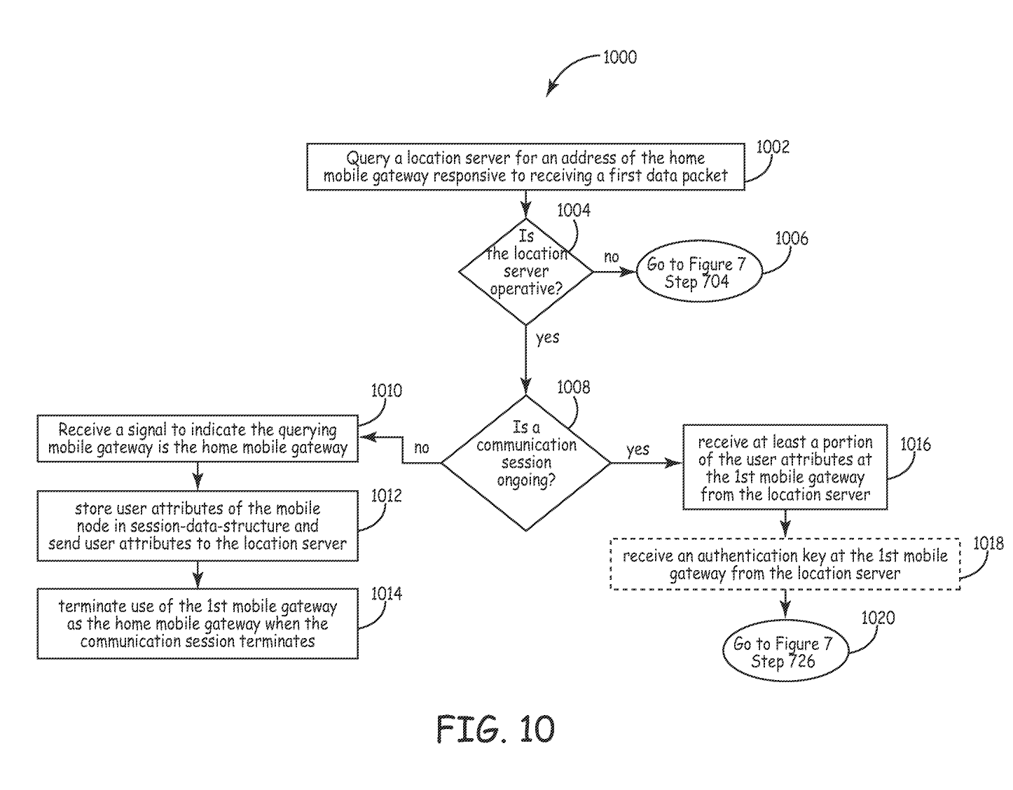

In another implementation of this embodiment, a look-up table is used in combination with a broadcast or multicast search protocol to improve the time required for a search. In one implementation of such an embodiment, a fixed subset represented generally by the numeral 12 of mobile gateways 110 (1-4) are configured to use IP tables that include a mapping between blocks of user IP addresses and the mobile gateway to which the user address belongs. In this case, the speed of communication between the mobile gateways 110 in the fixed subset 12 is increased and the search protocol is not implemented when a tunnel is to be opened between any two of the mobile gateways 110 (1-4) in the fixed subset 12. In yet another implementation of this embodiment, the fixed subset 12 of mobile gateways 110 (1-4) use a look-up table in combination with a broadcast or multicast search protocol to improve the time required for a search. FIGS. 9 and 10 describe such embodiments in greater detail.

A tunneling protocol is a network protocol that encapsulates data packets at a peer level or below to transport multiple protocols over a common network and to transport data packets in encrypted virtual private networks (VPNs). In one implementation of this embodiment, the tunnel is a generic routing encapsulation (GRE) tunnel. In another implementation of this embodiment, the tunnel is an IP tunnel such as IP in IP. The data to and from the user flows between the home mobile gateway and the visited mobile gateway through this tunnel. The services to which the user subscribes are applied at the anchored point, i.e., the home mobile gateway. Also, the home mobile gateway tracks the visited mobile gateway to which the user is connected. The IP network on which user data is tunneled can be the same or different than the network on which the search protocol is executed. In one implementation of this embodiment, VLAN 20-D executes the search and the IP network 20-C tunnels user IP datagrams between the visited mobile gateway 110-i and the home mobile gateway 110-j.

In one implementation of this embodiment, the tunneling protocol is a GRE protocol that contains a layer 3 inter-network packet exchange (IPX) data packet within a layer 3 IP data packet. In another implementation of this embodiment, the tunneling protocol is a virtual private LAN service (VPLS) that encapsulates a layer 2 Ethernet frame within a layer 3 IP data packet. In yet another implementation of this embodiment, the tunneling protocol is a transmitting NetWare IPX data packet within IP. In yet another implementation of this embodiment, the tunneling protocol is an IP security (IPsec) protocol based on GRE. In embodiments of this case, GRE is used with IPsec protocol to transmit routing protocol data packets from one mobile gateway 110 (such as a router) that does not natively support IPsec, to another mobile gateway 110 that does not natively support IPsec.

In one implementation of this embodiment, at least one access point 120 is a base station 120. The access points 120 (1-M) can be provided by the same or differing vendors. The software implemented by access points 120 (1-M) can be the same or different. The type of networks 20-A connecting the access points 120 (1-M) to the mobile gateways 110 (1-N) can be the same or different. In one implementation of this embodiment, IP network 20-A is a layer 3 network like an IP network. In another implementation of this embodiment, IP network 20-A is a layer 2 network such as a VLAN over a Gigabit Ethernet.

In one implementation of this embodiment, at least one access point 120 is a base station 120 communicatively coupled to a portion of the communication system 5 that is a wireless metropolitan area network (WMAN). In another implementation of this embodiment, at least one access point 120 is communicatively coupled to a wireless local area network (WLAN) portion of the communication system 5. In yet another implementation of this embodiment, at least one access point 120 is a base station 120 communicatively coupled to a portion of the communication system 5 that is a WiMAX network while at least one other access point 120 is communicatively coupled to a WLAN portion of the communication system 5. In another implementation of this embodiment, the mobile gateway is an access router. In yet another implementation of this embodiment, the mobile node 100 is laptop configured for communication in a WLAN. In yet another implementation of this embodiment, the mobile node 100 is laptop configured for communication in an 802.16 compliant network. In yet another implementation of this embodiment, the mobile node 100 is laptop configured for communication in both a WLAN and in an 802.16 compliant network.

Thus, communication over communication system 5 is transparent to the protocols, software and networks associated with the various access points 120 (1-M) due to the mobile-gateway-communication network 10.

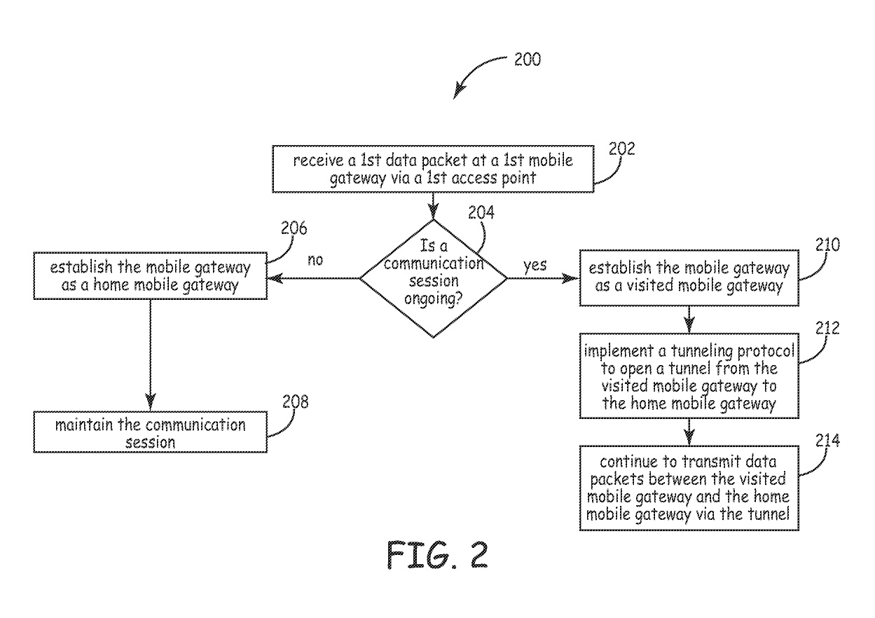

FIG. 2 is a flow diagram of one embodiment of a method 200 to enable mobility while connected to an Internet protocol network in accordance with the present invention. A mobile node that moves during a communication session disconnects from a first access point and connects to a second access point once the second access point is accessible and the first access point is no longer accessible. Upon receipt of a first data packet from a mobile node, each mobile gateway determines if the communication session is in progress. Method 200 describes how the determination affects the function of the mobile gateway.

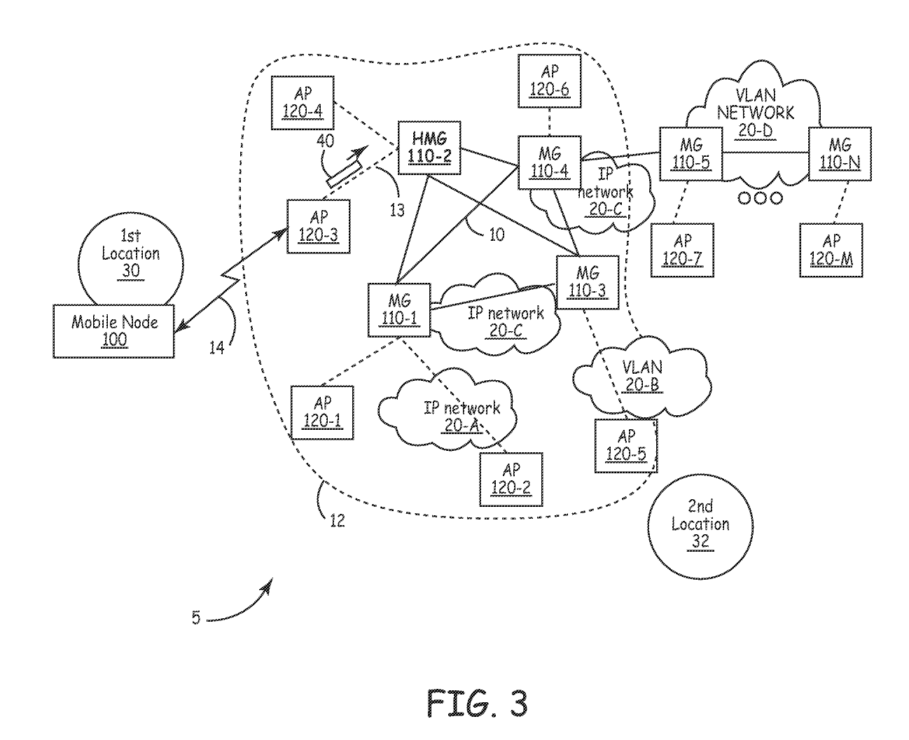

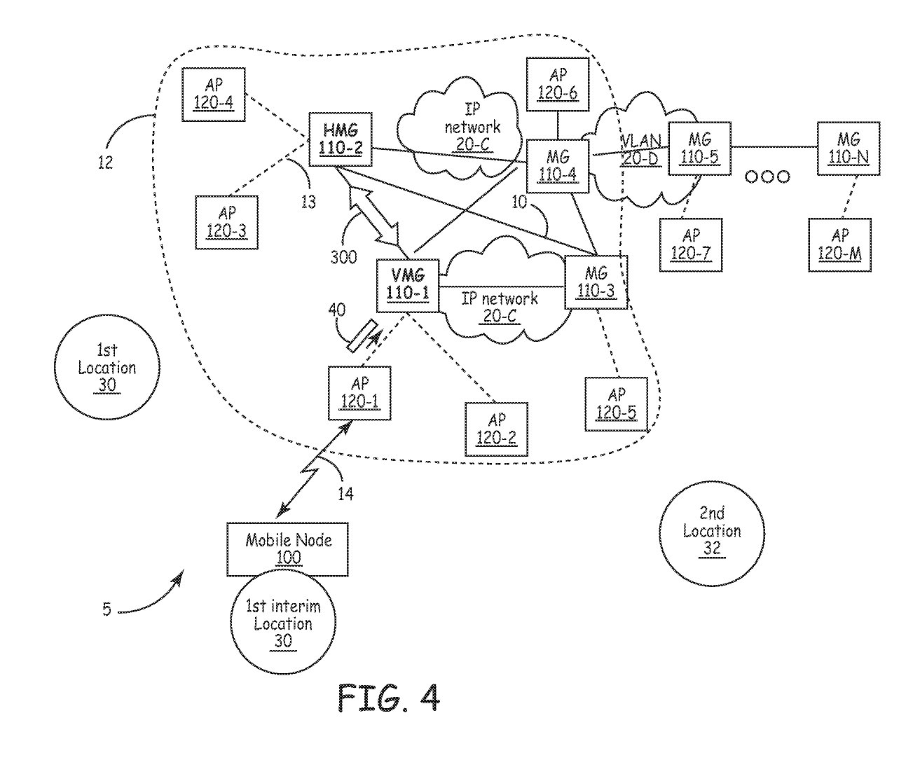

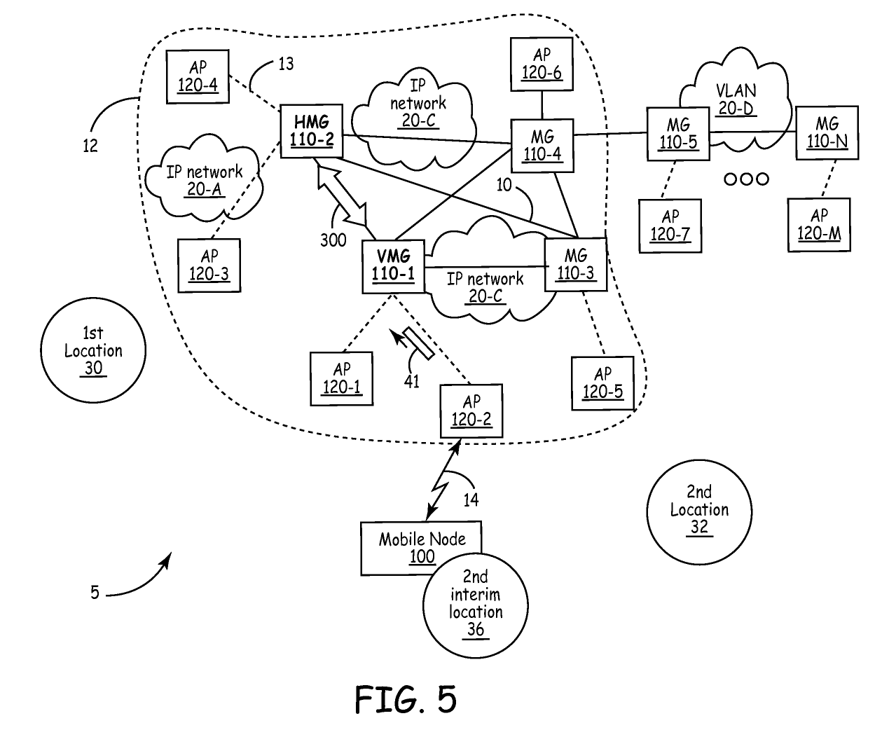

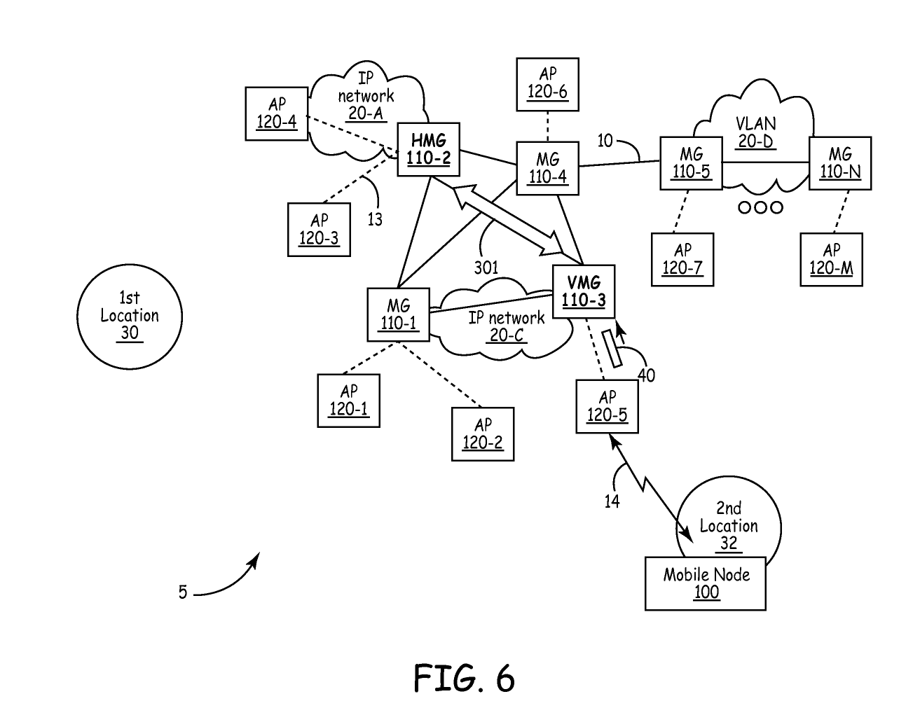

Method 200 is described with reference to a moving mobile node 100 that is communicatively coupled to the communication system 5 as shown in FIGS. 3-6. FIG. 3 is a block diagram of a mobile-gateway-communication network 5 communicatively coupled to a mobile node 100 located at a first location represented generally by the circle labeled 30 in accordance with the present invention. FIG. 4 is a block diagram of the mobile-gateway-communication network 5 communicatively coupled to the mobile node 100 located at a first interim location represented generally by the circle labeled 34 in accordance with the present invention. FIG. 5 is a block diagram of the mobile-gateway-communication network 10 communicatively coupled to the mobile node 100 located at a second interim location represented generally by the circle labeled 36 in accordance with the present invention. FIG. 6 is a block diagram of a mobile-gateway-communication network 10 communicatively coupled to a mobile node 100 located at a second location represented generally by the circle labeled 32 in accordance with the present invention. In this exemplary implementation shown sequentially as FIGS. 3-6, the mobile node 100 is moving from first location 30 to second location 32 while seamlessly transmitting and receiving data packets, such as data packets 40. The radio frequency access network is represented generally by the numeral 14, which labels the lightening-bolt shown between the mobile node 100 and the access point 120-3 in FIG. 3. The relative location of the home mobile gateways 110 and the access point 120 may be slightly different in the FIGS. 3-6 to accommodate additional details in the communication system 5.

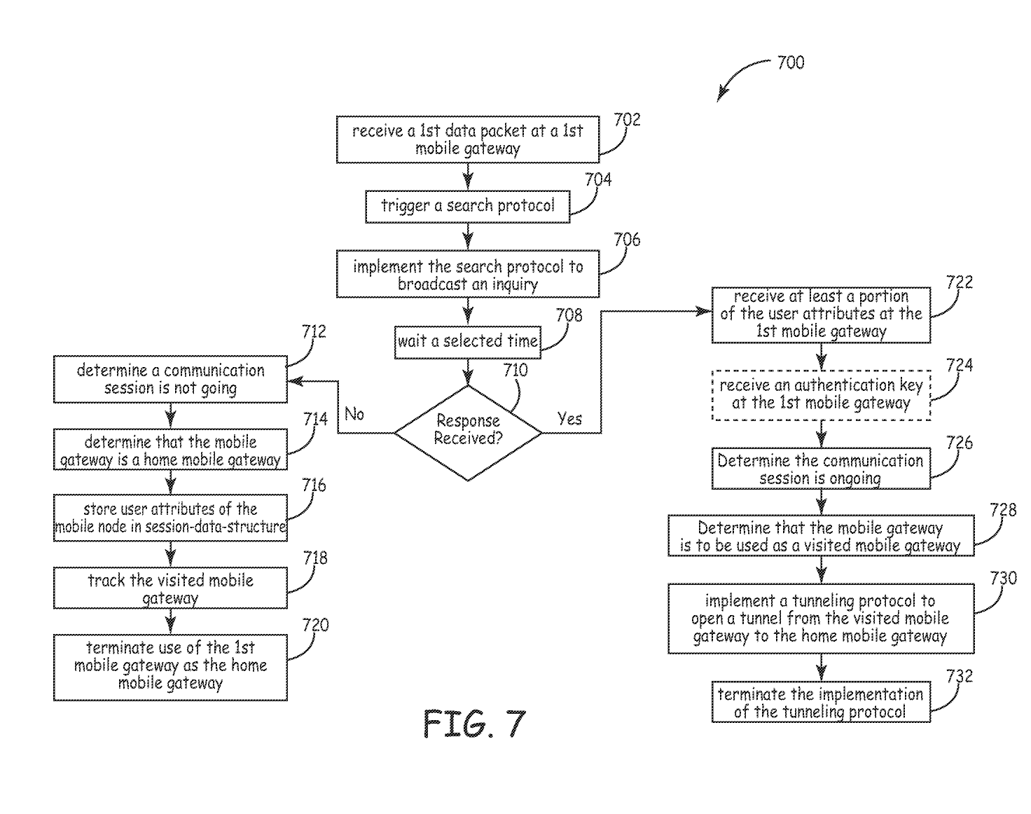

The method 200 starts by receiving a first data packet 40 at a first mobile gateway (for example, mobile gateway 110-2 shown as home mobile gateway (HMG) 110-2 in FIG. 3) in a mobile-gateway-communication network 10 via a first access point (for example, access point 120-3) implementing a first protocol (202). The mobile gateway determines if a communication session is ongoing (204). The process by which the mobile gateway makes that determination is described below with reference to steps 704-710 of method 700 shown in FIG. 7. As defined herein, the first data packet is the first data packet received at a given mobile gateway during the communication session.

If the communication session is not ongoing, the mobile gateway is established as a home mobile gateway for the duration of the communication session (206). This scenario is shown in FIG. 3. At the first location 30, the mobile node 100 is accessible to the first access point 120-3. The first data packet 40 is sent from the mobile node 100 to the mobile gateway 110-2 via first access point 120-3. The process by which the mobile gateway 110-2 is established as a home mobile gateway 110-2 is described below with reference to steps 714-716 of method 700 shown in FIG. 7.

The communication session is maintained with the mobile node 100 (208) via the home mobile gateway 110-2 even when the mobile node 100 connects to a second access point (such as access point 120-1), which implements a second protocol and is communicatively coupled to another mobile gateway, such as mobile gateway 110-1.

If the communication session is ongoing, the mobile gateway is established as a visited mobile gateway (210). This scenario is shown in FIG. 4. The mobile node 100 has moved from the first location 30 (FIG. 3) to the first interim location 34. The access point 120-1 is accessible from the first interim location 34 of the mobile node 100. The first data packet 40 is sent from the mobile node 100 to the mobile gateway 110-1 (shown in FIG. 4 as visited mobile gateway (VMG) 110-1) via access point 120-1. The process by which the mobile gateway 110-1 is established as a visited mobile gateway 110-1 is described below with reference to steps 722-728 of method 700 shown in FIG. 7.

In one embodiment of the method 200, the transport network 13 is a layer 2 network comprised of access points 120 (1-M) that are bridged configured according to the Institute of Electrical and Electronics Engineers (IEEE) 802.1 d standard. The mobile node 100 moving to a new IP network 20-A, is still configured with the home default gateway IP address and home default gateway media access control (MAC) address. A switch within the visited access IP network 20-A will not properly switch the user data packets unless the visited mobile gateway 110 is configured with the home default gateway IP address and the home default gateway MAC address. This configuration can be done manually or automatically using a virtual router redundancy protocol (VRRP) mechanism. The VRRP mechanism configures each access network interface on the mobile gateway 110 with the same virtual MAC address using the same VRRP group. In this configuration, all mobile gateways 110 (1-N) connect to separate access networks (for example, networks 20-B) and therefore each VRRP access interface acts as a master router. The default gateway IP address is solved by configuring each mobile gateway with a loopback interface configured with the same IP address, the default gateway IP address. All of the above configurations are identical in all the mobile gateways 110 (1-N), simplifying the implementation, integration, and maintenance of the mobile-gateway-communication network 10.

As shown in FIG. 4, the mobile gateway 110-1 implements a tunneling protocol to open a tunnel 300 from the visited mobile gateway 110-1 to the home mobile gateway 110-2 (212). Data packets are then transmitted over the mobile-gateway-communication network 10 between the visited mobile gateway 110-1 and the home mobile gateway 110-2. The tunnel 300 is indicated as a double block arrow in the mobile-gateway-communication network 10.

The visited mobile gateway 110-1 continues to implement the tunneling protocol to transmit data packets between the visited mobile gateway 110-1 and the home mobile gateway 110-2 via the tunnel 300 when the mobile node 100 connects to another access point that is also communicatively coupled to the visited mobile gateway 110-1 (214). This scenario is shown in FIG. 5. The mobile node 100 has moved from the first interim location 34 to the second interim location 36. The second access point 120-2 is accessible from the second interim location 36 of the mobile node 100. The data packet 41 is sent from the mobile node 100 to the mobile gateway 110-1 via second access point 120-2. In this case, since the mobile gateway 110-1 is already established as the visited mobile gateway 110-1, the data packet 41 is not a first data packet for the visited mobile gateway 110-1 based on the definition of first data packet used herein.

As shown in FIG. 6, when the mobile node 100 moves to the second location 32, the access point 120-5 becomes accessible to the mobile node 100. The mobile gateway 110-3 is communicatively coupled to the access point 120-5. A data packet 40 is sent from the mobile node 100 to the mobile gateway 110-3 via access point 120-5. After the mobile gateway 110-3 determines a communication session is ongoing, the visited mobile gateway 110-3 implements a tunneling protocol to open a tunnel 301 from the visited mobile gateway 110-3 to the home mobile gateway 110-2. Data packets are then transmitted over the mobile-gateway-communication network 10 between the visited mobile gateway 110-1 and the home mobile gateway 110-2. The tunnel 301 is indicated as a double block arrow in the mobile-gateway-communication network 10.

In this manner, a mobile node 100 that initiates a communication session at a first location 30 via a first access point and a first mobile gateway (for example access point 120-3 and mobile gateway 110-2) uses tunnels opened by the visited mobile gateways over the mobile-gateway-communication network 10 to continuously maintain the communication session via the first mobile gateway while moving to a second location 32.

FIG. 7 is a flow diagram of one embodiment of a method 700 to enable mobility while connected to an Internet protocol network in accordance with the present invention. Method 700 outlines how mobile gateways 110 (1-N) determine if a communication session is ongoing. Method 700 also outlines how the home mobile gateway and visited mobile gateway are established in order to function accordingly. Method 700 is described with reference to a moving mobile node 100 that is communicatively coupled to the communication system 5 as shown in FIGS. 3-4.

The method 700 starts by receiving a first data packet 40 at a first mobile gateway 110-2 in a mobile-gateway-communication network 10 via a first access point 120-3 implementing a first protocol (702) (FIG. 3). In one implementation of this embodiment, an identical virtual IP address and an identical virtual media access control address topology on each mobile gateway in the mobile-gateway-communication network 10 are configured to enable a handoff and communication across an independent cluster architecture network topology. A search protocol is triggered (704) to search for an ongoing communication session. In one implementation of this embodiment, the trigger for the visited mobile gateway to do a search is a remote authentication dial in user service (RADIUS) authentication request by the new access point, as for example, in 802.1X protocol for WLAN. In other embodiments, the trigger is a dynamic host configuration protocol (DHCP) DISCOVER/Request message, an indication from the access point, or an IP packet sent by the mobile node 100. The search for an ongoing communication session can be according to the IP address of the user, the MAC address of the user, the user-name, or according to a combination of these attributes. In yet another implementation of this embodiment, the first data packet is the trigger for a search protocol and steps 702 and 704 are merged into one step. For example, the mobile node 100 can send an extensible authentication protocol data packet as the first data packet, which the access point 120 then encapsulates in an 802.1x RADIUS request. In this case, the access point 120 sends the triggering RADIUS message, which is the first data packet, to the mobile gateway 110 serving as its RADIUS proxy.

The search protocol is implemented to broadcast an inquiry from the mobile gateway 110-2 to the other mobile gateways 110-1 and 110 (3-N) connected to the mobile-gateway-communication network responsive to receiving the first data packet 40 (706). In one implementation of this embodiment, the search protocol is implemented to multicast the inquiry from the mobile gateway 110-2 to the fixed subset 12 of the mobile gateways 110 (1-4) responsive to receiving the first data packet 40. If a communication session already exists on one of the mobile gateways, the mobile gateway only replies if it is the home mobile gateway 110-2. In one implementation of this embodiment, before applying the search protocol, the visited mobile gateway pre-authenticates the new session using a RADIUS server. In one such implementation, the RADIUS server directs the mobile gateway to disable roaming and to not apply the search protocol. In that case, a new communication session is established on the mobile gateway to which the mobile node 100 is currently attached. This disable-roaming feature may be useful at times. For example, a vendor may want to disable roaming for a selected set of users if their service is temporarily suspended or their company does not want to authorize roaming for them. In that case, the user applications will not experience smooth functioning. The ongoing applications will have to restart.

The mobile gateway 110-2 waits for a selected time (708) after the inquiry is broadcast or multicast. In one implementation of this embodiment, the selected time is configurable time known at the mobile gateways 110 (1-N). In one implementation of this embodiment, the response is received within 2 to 3 milliseconds. The selected time can be set to permit several retries. In that case, the pre-selected time is set to be on the order of tens of milliseconds.

If no response is received within the selected time frame (710), the flow proceeds to step 712 and the mobile gateway determines that a communication session is not ongoing (712). In this case, the first data packet 40 is the initial data packet sent from the mobile node 40 during the communication session and the mobile gateway 110-2 is the home mobile gateway for the duration of the communication session (714). The mobile gateway 110-2 stores the user attributes of the mobile node 100 in session-data-structure (716) to start a new communication session. The first mobile gateway 110-2 is the home mobile gateway 110-2 for the duration of the communication session. The session-data structure stores information specific to each user session such as the user IP address, the user device MAC address, the username, and the service name of the currently implemented service for this user. During the communication session, the home mobile gateway 110-2 tracks the visited mobile gateway (718). When the communication session terminates, the use of the mobile gateway 110-2 as the home mobile gateway 110-2 is also terminated (720).

If a response is received within the selected time frame (710), the flow proceeds to step 722. The mobile gateway (such as mobile gateway 110-1 in FIG. 4) receives all or a portion of the stored user attributes since the home mobile gateway 110-2 sent all or a portion of the stored user attributes in response to receiving the inquiry broadcast from the mobile gateway 110-1 in step 706. The user attributes include the user IP address, user MAC address, user-name, user current service name and/or other optional parameters.

In one optional implementation of this embodiment, the visited mobile gateway 110-1 receives an authentication key from the home mobile gateway 110-2 (724) as part of the response from the home mobile gateway 110-2. In one implementation of this embodiment, the visited mobile gateway 110-1 receives an 802.1x authentication key to speed up the key distribution in roaming. In response to receiving the user attributes, the mobile gateway 110-1 determines the communication session is ongoing (726). Then the mobile gateway 110-1 determines it is to be used as a visited mobile gateway (728).

The visited mobile gateway 110-1 implements a tunneling protocol to open a tunnel 300 from the visited mobile gateway 110-1 to the home mobile gateway 110-2 (730). Once the tunneling protocol is used to open the tunnel 300 (FIG. 4) between the home mobile gateway 110-2 and the mobile gateway 110-1, the mobile gateway 110-1 is the visited mobile gateway 110-1.

If the mobile node connects to yet another access point that is not communicatively coupled to the visited mobile gateway 110-1, the tunnel 300 between the visited mobile gateway 110-1 and the home mobile gateway 110-2 is terminated (732) and the mobile gateway 110-1 is no longer the visited mobile gateway 110-1 for the communication session. Likewise, if the mobile node 100 ends the communication session, the tunnel 300 between the visited mobile gateway 110-1 and the home mobile gateway 110-2 is terminated (732).

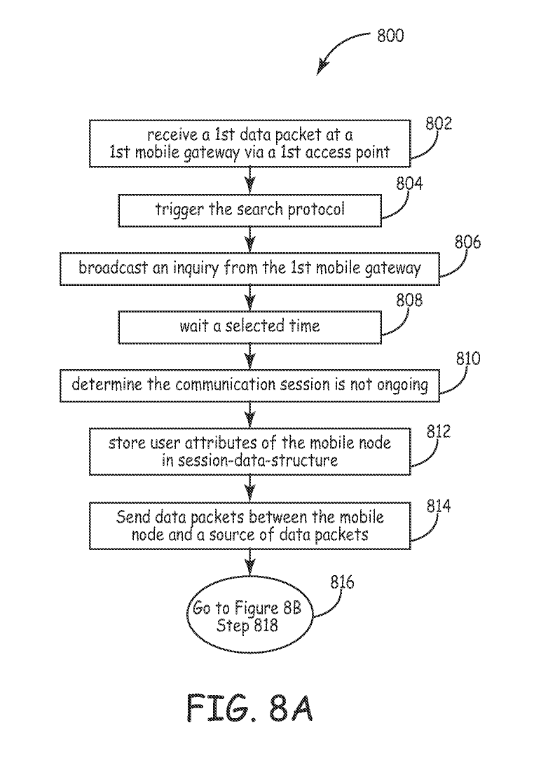

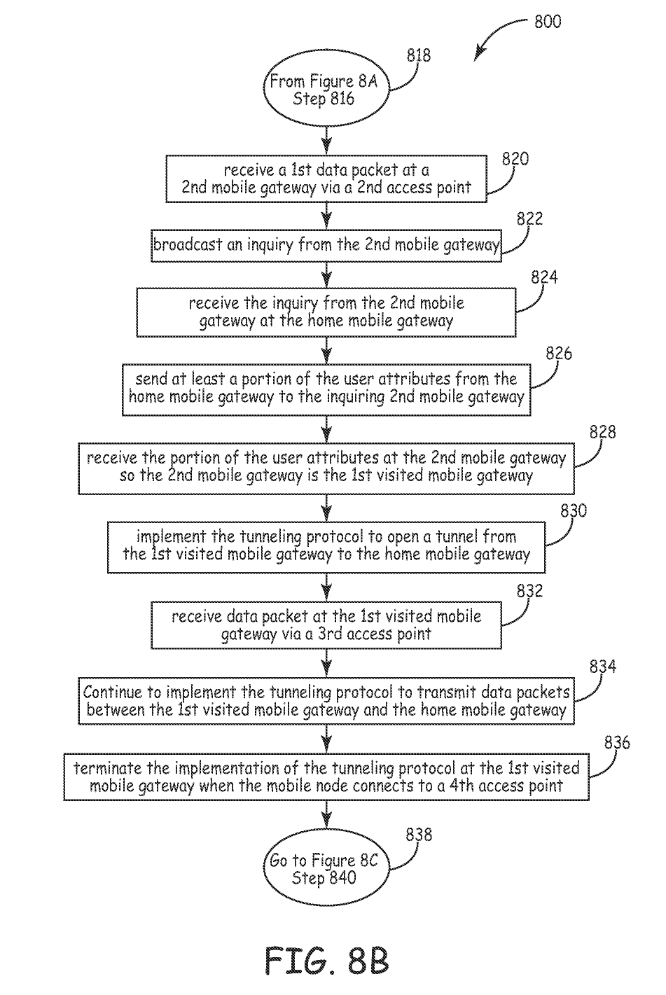

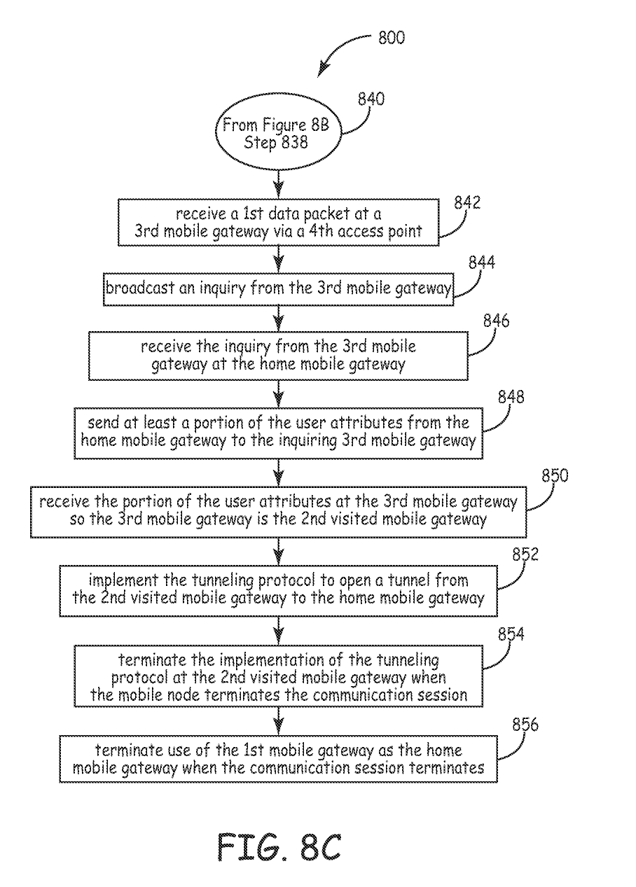

FIGS. 8A-8C are flow diagrams of one embodiment of a method 800 to enable mobility while connected to an Internet protocol network in accordance with the present invention. Method 800 outlines in detail how the home mobile gateway tracks the visited mobile gateways during the communication session in which the mobile node 100 moves from the first location 30 to the second location 32.

The method 800 starts, as shown in FIG. 8A, by receiving a first data packet 40 at a first mobile gateway 110-2 in a mobile-gateway-communication network 10 via a first access point 120-3 (802). In one implementation of this embodiment, the first access point 120-3 implements a first protocol. A search protocol in the mobile gateway 110-2 is triggered (804) as described above with reference to step 704 of method 700 in FIG. 7. The mobile gateway 110-2 implements the search protocol (806) to broadcast an inquiry over the mobile-gateway-communication network 10. The search protocol is used to determine if the communication session is ongoing. The mobile gateway 110-2 waits a selected time for a response from any one of the other mobile gateways 110 (808) as described above with reference to step 708 of method 700 in FIG. 7. The mobile gateway 110-2 does not receive any response within the allotted time so the mobile gateway 110-2 determines that it is a communication session is not ongoing (810) as described above with reference to step 712 of method 700 in FIG. 7. The mobile gateway 110-2 stores the user attributes of the mobile node 100 in session data structure (812) to start a new communication session as described above with reference to step 716 of method 700 in FIG. 7. The first mobile gateway 110-2 is now the home mobile gateway 110-2. The home mobile gateway 110-2 sends data packets between the mobile node 100 and the source of the data packets addressed to the mobile node 100 via the first access point 120-3 as long as the mobile node is accessible to the first access point 120-3 (814). Step 816 directs the flow of method 800 to step 818 in FIG. 8B.

The method 800 continues at step 818 is FIG. 8B, which indicates the flow has been received from step 816 in FIG. 8A. As shown in FIG. 4, a second mobile gateway 110-1 in the mobile-gateway-communication network 10 receives a first data packet 40 via the second access point 120-1 (820). In one implementation of this embodiment, access point 120-1 implements a second protocol that is different from the protocol implemented by the first access point 120-3. In another implementation of this embodiment, first access point 120-3 and second access point 120-1 implement the same protocol.

The second mobile gateway 110-1 implements a search protocol to broadcast or multicast an inquiry from the second mobile gateway 110-1 to at least a fixed subset 12 of the other mobile gateways 110 (1-N) over the dedicated line of the mobile-gateway-communication network 10 (822). The home mobile gateway 110-2 receives the inquiry from the second mobile gateway 110-1 (824). The home mobile gateway 110-2 sends at least a portion of the user attributes from the home mobile gateway 110-2 to the second mobile gateway 110-1 (826) over the dedicated line of the mobile-gateway-communication network 10. The second mobile gateway 110-1 receives the user attributes from the home mobile gateway 110-2 and the second mobile gateway 110-1 becomes the visited mobile gateway 110-1 (828). At this point in time, the second mobile gateway 110-1 is the first visited mobile gateway 110-1 during the communication session.

The first visited mobile gateway 110-1 implements a tunneling protocol to open a tunnel 300 from the first visited mobile gateway 110-1 to the home mobile gateway 110-2(830). Data packets are transmitted between the first visited mobile gateway 110-1 and the home mobile gateway 110-2 via the tunnel 300 while the mobile node 100 is connected to the second access point 120-1. The downstream data packets sent from the data-packet source in the Internet to the mobile node 100 are sequentially transmitted via the home mobile gateway 110-2, the first visited mobile gateway 110-1, and the second access point 120-1 before reaching the mobile node 100. The upstream data packets sent from the mobile node 100 to the Internet are sequentially transmitted via the second access point 120-1, the first visited mobile gateway 110-1, and the home mobile gateway 110-2, before reaching the data-packet source in the Internet.

As shown in FIG. 5, the mobile node 100 moves to the second interim location 36 and is now has access to the access point 120-2. The access point 120-2 becomes the third access point to be transmitting data packets during this exemplary communication session. The third access point 120-2 is communicatively coupled to the mobile gateway 110-1, thus the second mobile gateway 110-1 (also referred to as first visited mobile gateway 110-1) is still transmitting the data packets. The first visited mobile gateway 110-1 receives a data packet 41 via the third access point 120-2 that implements the second protocol (832). The first visited mobile gateway 110-1 continues to implement the tunneling protocol to transmit data packets between the first visited mobile gateway 110-1 and the home mobile gateway 110-2 while the mobile node 100 is connected to the third access point 120-2 (834).

At this point in time, the downstream data packets are sequentially transmitted via the home mobile gateway 110-2, the first visited mobile gateway 110-1, and the third access point 120-2 before reaching the mobile node 100. The upstream data packets are sequentially transmitted via the third access point 120-2, the first visited mobile gateway 110-1, and the home mobile gateway 110-2, before reaching the data-packet source in the Internet.

As shown in FIG. 6, the mobile node 100 has moved to the second location 32 and now has access to the access point 120-5. The access point 120-5 is the fourth access point to be transmitting data packets during this exemplary communication session. The first visited mobile gateway 110-1 terminates the implementation of the tunneling protocol and closes tunnel 300 when the mobile node 100 connects to the fourth access point 120-5 that is communicatively coupled to another mobile gateway (836). Step 838 directs the flow of method 800 to step 840 in FIG. 8C.

The method 800 continues at step 840 is FIG. 8C, which indicates the flow has been received from step 838 in FIG. 8B. The third mobile gateway 110-3 in the mobile-gateway-communication network 10 receives the first data packet 40 from the mobile node 100 via the fourth access point 120-5. In one implementation of this embodiment, the fourth access point 120-5 implements a third protocol (842).

The third mobile gateway 110-3 implements a search protocol to broadcast or multicast an inquiry to at least a fixed subset 12 of the other mobile gateways 110 (1-N) (844) over the dedicated line of the mobile-gateway-communication network 10. The home mobile gateway 110-2 receives the inquiry from the third mobile gateway 110-3 (846). The home mobile gateway 110-2 sends at least a portion of the user attributes to the inquiring third mobile gateway 110-3 (848) over the dedicated line of the mobile-gateway-communication network 10. The third mobile gateway 110-3 receives at least a portion of the user attributes from the home mobile gateway 110-2 and the third mobile gateway 110-1 is then established as the second visited mobile gateway 110-3 (850). At this point in time, the third mobile gateway 110-3 is the second visited mobile gateway 110-3 in the communication session.

The second visited mobile gateway 110-3 implements a tunneling protocol to open a tunnel 301 from the second visited mobile gateway 110-3 to the home mobile gateway 110-2. The data packets are transmitted between the second visited mobile gateway 110-3 and the home mobile gateway 110-2 while the mobile node 100 is connected to the fourth access point 120-5 (852).

At this point in time, the downstream data packets sent from the data-packet source in the Internet to the mobile node 100 are sequentially transmitted via the home mobile gateway 110-2, the second visited mobile gateway 110-3, and the fourth access point 120-5 before reaching the mobile node 100. The upstream data packets sent from the mobile node 100 to the Internet are sequentially transmitted via the fourth access point 120-5, the second visited mobile gateway 110-3, and the home mobile gateway 110-2 before reaching the data-packet source in the Internet.

The second visited mobile gateway 110-3 terminates the implementation of the tunneling protocol and closes the tunnel 301 when the mobile node 100 connects to a fifth access point 120-5 that is communicatively coupled to another mobile gateway. Alternatively, the second visited mobile gateway 110-3 terminates the implementation of the tunneling protocol and closes the tunnel 301 when the mobile node 100 terminates the communication session (854). Likewise, when the communication session terminates, the first mobile gateway 110-2 is no longer used as the home mobile gateway 110-2 (856).

In this manner, when the mobile node 100 initiates a communication session the first accessible mobile gateway is the home mobile gateway for the duration of the communication session while moving from the first location 30 to the second location 32. The communication session is maintained regardless of the protocol implemented by the access points. The communication session is also maintained regardless of the type of IP networks that are communicatively coupled to the mobile gateways. In one implementation of this embodiment, the communication system 5 includes a mobile-gateway-communication network 10 that is a dedicated virtual local area network. In another one implementation of this embodiment, the networks that are communicatively coupled to the mobile gateways are not IP networks but are other data-packet-based networks currently available and yet to be developed.

FIG. 9 is a block diagram of a mobile-gateway-communication network 15 communicatively coupled to a mobile node 100 in accordance with the present invention. Mobile-gateway-communication network 15 differs from mobile-gateway-communication network 10 of FIG. 1, in that the mobile-gateway-communication network 15 includes a location server 150 that is communicatively coupled to all the mobile gateways in the mobile-gateway-communication network 15. In one implementation of this embodiment, the location server 150 and the mobile gateways 110 (1-N) are part of a virtual local area network that connects all the mobile gateways 110 (1-N). The communication links between the location server 150 and the mobile gateways 110 (1-N) are dedicated links shown as bold lines. In one implementation of this embodiment, at least one communication link between the location server 150 and the mobile gateways 110 (1-N) is a wired communication link (for example, an optical fiber or copper wire communication link). In another implementation of this embodiment, the communication link between the location server 150 and the mobile gateway 110 (1-N) is a layer 2 shared medium type network like a virtual local area network (VLAN). In yet another implementation of this embodiment, the communication between the mobile gateways 110 (1-N) uses in the same IP network 20-C as the communication links between the mobile gateways 110 (1-N) and the location server 150. In yet another implementation of this embodiment, the communication links between the mobile gateways 110 (1-N) are in a separate dedicated network from the communication links between the mobile gateways 110 (1-N) and the location server 150.

As shown in FIG. 9, the mobile gateways 110 (1-N) each include a memory 115 to store IP tables. The IP tables in the memories 115 include maps to correlate blocks of user IP addresses and the mobile gateway 110 (1-N) in the mobile-gateway-communication network 15 to which the user address belongs. In one implementation of this embodiment, the blocks of user IP addresses are correlated to the mobile gateways 110 (1-4) in the fixed subset 12 of the mobile-gateway-communication network 15.

FIG. 10 is a flow diagram of one embodiment of a method 1000 to enable mobility while connected to an Internet protocol network 20 in accordance with the present invention. Method 1000 describes how the mobile-gateway-communication network 15 is implemented by the moving mobile node 100 that is communicatively coupled to the communication system 6 via access point 120-3 and mobile gateway 110-2 as shown in FIG. 9.

A mobile gateway 110-2 sends a query to a location server 150 for an address of a home mobile gateway responsive to receiving a first data packet 41 (1002). The mobile gateway 110-2 then waits a selected time to receive a response to the query. If the location server 150 is inoperative (1004), a signal indicating that the location server 150 is inoperative is sent to the querying mobile gateway 110-2 within the selected time. In one implementation of this embodiment, if the location server 150 is inoperative (1004), no signal is sent to the querying mobile gateway 110-2 and the lack of response within the selected time indicates that the location server 150 is inoperative. Once the mobile gateway 110-2 receives input indicating that the location server 150 is inoperative, the flow proceeds to step 1106 and the flow proceeds to step 704 of FIG. 7 (1006). The mobile gateway 110-2 then operates as described above with reference to FIG. 7 and steps 704-732. In this case, the mobile gateway 110-2 operates as if the location server 150 was not in the mobile-gateway-communication network 15.

If the location server 150 is brought back on line at a later time during the communication session, the other mobile gateways 110 (1-N) receiving the first data packet 41 will send a query to the location server 150 and then operate as described below with reference to steps 1008-1022.

If the location server 150 is operative (1004) and a communication session is not ongoing (1008), the flow proceeds to step 1010. If the communication session is not ongoing, the location server 150 receives the query sent during step 1002 and sends a signal to the querying mobile gateway 110-2 to indicate that the querying mobile gateway 110-2 is the home mobile gateway 110-2. The querying mobile gateway 110-2 receives the signal that indicates the querying mobile gateway 110-2 is the home mobile gateway 110-2 (1010).

The mobile gateway 110-2 stores the user attributes of the mobile node 100 in session-data-structure and sends the session-data-structure to the location server 150 (1012) to establish the first mobile gateway 110-2 as the home mobile gateway 110-2 for the duration of the communication session responsive to receiving the signal that indicates the querying mobile gateway 110-2 is the home mobile gateway. In one implementation of this embodiment, the mobile gateway 110-2 sends the session-data-structure to the location server 150 along with the inquiry of step 1002. In this case, the mobile gateway 110-2 stores the user attributes of the mobile node 100 in session-data-structure and does not send the session-data-structure to the location server 150 during step 1012. When the communication session terminates, the mobile gateway 110-2 is no longer used as the home mobile gateway (1014) for the mobile node 100.

If the location server 150 is operative (1004) and the communication session is ongoing, the flow proceeds to step 1016. The mobile gateway 1110-2 receives at least a portion of the user attributes of the mobile node 100 and the address of the home mobile gateway from the location server 150. In one optional implementation of this embodiment, the visited mobile gateway 110-1 receives an authentication key from the location server 150 (1018) along with the address of the home mobile gateway. This speeds up the authentication process at the visited mobile gateway 110-1. Then the flow proceeds to step 726 of FIG. 7 (1020) and the mobile gateway operates as described above with reference to FIG. 7 and steps 726-732.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A method to enable mobility while connected to an Internet protocol network, comprising:
receiving a first data packet from a mobile node at a first mobile gateway in a mobile-gateway-communication network via a first access point;
determining if a communication session is ongoing responsive to receiving the first data packet;
when it is determined that a communication session is not ongoing, establishing the first mobile gateway as a home mobile gateway for the duration of the communication session; and
when the mobile node connects to a second mobile gateway in the mobile-gateway-communication network via a second access point during the communication session, opening a tunnel from the second mobile gateway to the home mobile gateway, wherein the communication session is maintained regardless of the protocol implemented by the mobile node and the access points.

2. The method of claim 1, wherein determining if a communication session is ongoing comprises:
implementing a search protocol to broadcast an inquiry from a mobile gateway to at least a subset of the other mobile gateways connected to the mobile-gateway-communication network responsive to receiving the first data packet; and
waiting a selected time to receive a response to the inquiry.

3. The method of claim 2, wherein establishing the first mobile gateway as a home mobile gateway comprises:
when no response is received, storing the user attributes of the mobile node in the session-data-structure.

4. The method of claim 2, further comprising:
triggering the implementation of the search protocol by one of a RADIUS proxy authentication request, a DHCP discover/request, by an IP data packet, and by an indication from the access point.

5. The method of claim 1, the method further comprising:
receiving a first data packet from the mobile node at the second mobile gateway via the second access point;
implementing a search protocol to broadcast an inquiry from the second mobile gateway to at least a subset of the other mobile gateways connected to the mobile-gateway-communication network responsive to receiving the first data packet to determine if the communication session is ongoing;
receiving a response to the inquiry from the home mobile gateway via the mobile-gateway-communication network to determine that the communication session is ongoing;
implementing a tunneling protocol to open the tunnel responsive to receiving the response, wherein implementing the tunneling protocol establishes the second mobile gateway as a visited mobile gateway;
transmitting data packets between the visited mobile gateway and the home mobile gateway via the tunnel; and
terminating implementing the tunneling protocol at the visited mobile gateway when the mobile node one of ends the communication session, and connects to yet another access point not communicatively coupled to the visited mobile gateway.

6. The method of claim 5, further comprising:
continuing to transmit data packets between the visited mobile gateway and the home mobile gateway via the tunnel when the mobile node connects to yet another access point communicatively coupled to the visited mobile gateway.

7. The method of claim 1, further comprising:
terminating use of the first mobile gateway as the home mobile gateway when the communication session terminates.

8. The method of claim 1, wherein determining if a communication session is ongoing comprises:
querying a location server for an address of the home mobile gateway responsive to receiving the first data packet; and
waiting a selected time to receive a response to the query, and wherein establishing the first mobile gateway as the home mobile gateway comprises:
receiving a signal indicating the querying mobile gateway is the home mobile gateway responsive to the querying; and
storing the user attributes of the mobile node in the session-data-structure.

9. The method of claim 8, further comprising:
when the location server is inoperative, implementing a search protocol to broadcast an inquiry from the first mobile gateway to at least a subset of the other mobile gateways connected to the mobile-gateway-communication network responsive to receiving the first data packet from the mobile node;
waiting a selected time to receive a response to the inquiry; and
when no response is received, storing the user attributes of the mobile node in the session-data-structure.

10. The method of claim 1, further comprising:
receiving a first data packet from the mobile node at the second mobile gateway via the second access point;
querying a location server for an address of the home mobile gateway responsive to receiving the first data packet;
when the address of the home mobile gateway is received from the location server, implementing a tunneling protocol to open the tunnel, wherein implementing the tunneling protocol establishes the second mobile gateway as a visited mobile gateway;
transmitting data packets between the home mobile gateway and the first mobile gateway via the tunnel; and
terminating implementing the tunneling protocol at the visited mobile gateway when the mobile node one of ends the communication session, and connects to yet another access point not communicatively coupled to the visited mobile gateway.

11. The method of claim 10, further comprising:
when the location server is inoperative, implementing a search protocol to broadcast an inquiry from the second mobile gateway to at least a subset of the other mobile gateways connected to the mobile-gateway-communication network;
receiving a response to the inquiry from the home mobile gateway via the mobile-gateway-communication network;
implementing a tunneling protocol to open the tunnel, wherein implementing the tunneling protocol establishes the second mobile gateway as a visited mobile gateway;
transmitting data packets between the home mobile gateway and the first mobile gateway via the tunnel; and
terminating implementing the tunneling protocol at the visited mobile gateway when the mobile node one of ends the communication session, and connects to yet another access point not communicatively coupled to the visited mobile gateway.

12. A method to enable mobility while connected to an Internet protocol network, comprising:
receiving a first data packet at a mobile gateway via a first access point implementing a first protocol, wherein the data packet is sent from a mobile node;
responsive to receiving the first data packet, implementing a search protocol to broadcast an inquiry over a mobile-gateway-communication network to one of determine that the mobile gateway is to be used a home mobile gateway, and determine that the mobile gateway is to be used a visited mobile gateway; and
when the mobile gateway determines it is to be used as a visited mobile gateway, the mobile gateway opens a tunnel to the home mobile gateway via the mobile-gateway-communication network, wherein the communication session is maintained regardless of the protocol implemented by the mobile node, wherein the home mobile gateway is used for the duration of the communication session, wherein the visited mobile gateway is used for at least the duration of the communicative coupling between the first access point and the mobile node, and wherein.

13. The method of claim 12, further comprising:
when a response to the inquiry is not received from the other mobile gateways in the mobile-gateway-communication network, establishing the mobile gateway as the home mobile gateway; and
when a response to the inquiry is received from one of the other mobile gateways in the mobile-gateway-communication network, establishing the mobile gateway as the visited mobile gateway.

14. The method of claim 13, wherein establishing the mobile gateway as the home mobile gateway comprises:
storing user attributes of the mobile node in session-data-structure;
maintaining the communication session with the mobile node when the mobile node connects to a second access point implementing a second protocol, wherein the second access point is communicatively coupled to a visited mobile gateway in the mobile-gateway-communication network; and
terminating use of the home mobile gateway when the communication session terminates.

15. The method of claim 14, further comprising:
receiving the inquiry being broadcast in the search protocol via the mobile-gateway-communication network at the home mobile gateway; and
sending at least a portion of the user attributes to the inquiring mobile gateway from the home mobile gateway via the mobile-gateway-communication network responsive to receiving the inquiry.

16. The method of claim 15, wherein establishing the mobile gateway as the visited mobile gateway comprises:
receiving the portion of the user attributes at the visited mobile gateway from the home mobile gateway;
implementing a tunneling protocol to open the tunnel to the home mobile gateway via the mobile-gateway-communication network; and
transmitting data packets between the visited mobile gateway and the home mobile gateway via the tunnel.

17. The method of claim 16, further comprising:
receiving an authentication key from the home mobile gateway at the visited mobile gateway

18. The method of claim 16, further comprising:
tracking the visited mobile gateway from the home mobile gateway responsive to implementing the tunneling protocol to transmit the received data packets to the home mobile gateway.

19. The method of claim 16, wherein the visited mobile gateway is a first visited mobile gateway, the method further comprising:
terminating implementing the tunneling protocol at the first visited mobile gateway when the mobile node connects to a second access point communicatively coupled to another mobile gateway, wherein the other mobile implements the search protocol to broadcast an inquiry over the mobile-gateway-communication network to all mobile gateways connected to the mobile-gateway-communication network responsive to receiving a data packet from the mobile node via the second access point, wherein the other visited mobile gateway is established as a second visited mobile gateway.

20. The method of claim 19, wherein at least one of the first visited mobile gateway and the second visited mobile gateway implements a second protocol.

21. The method of claim 12, further comprising:
triggering the search protocol by one of a RADIUS proxy authentication request, a DHCP discover/request, an IP data packet, and an indication from the access point.

22. The method of claim 12, further comprising:
communicatively coupling at least one access point to each mobile gateway, wherein each access point is communicatively coupled to only one mobile gateway, and wherein at least one of the access points implements a second protocol.

23. The method of claim 12, further comprising:
configuring an identical virtual IP address and an identical virtual media access control address topology on each mobile gateway to enable a handoff and communication across an independent cluster architecture network topology.

24. A communication system comprising:
a plurality of mobile gateways forming a mobile-gateway-communication network, each mobile gateway configured to implement a search protocol and a tunneling protocol; and
a plurality of access points each communicatively coupled to one of the mobile gateways and each access point configured to transmit and receive signals from mobile nodes implementing a first protocol, wherein a mobile node initiating a communication session with an Internet protocol network at a first location via a first access point and a first mobile gateway continuously maintains the communication session via the first mobile gateway while moving to a second location, wherein a second mobile gateway in the mobile-gateway communication network is communicatively coupled to the mobile node via a second access point, wherein the second mobile gateway opens a tunnel from the second mobile gateway to the first mobile gateway over the mobile-gateway-communication network to maintain the communication session with the mobile node and the first mobile gateway.

25. The communication system of claim 24, further comprising:
a plurality of other access points each communicatively coupled to one of the mobile gateways and each other access point configured to transmit and receive signals from mobile nodes implementing a second protocol, wherein the communication session is maintained with the mobile node and the first mobile gateway regardless of which protocol is being implemented by the access points and the mobile node.

26. The communication system of claim 25, wherein the mobile-gateway-communication network is a dedicated virtual local area network.

27. The communication system of claim 26, further comprising a location server on the virtual local area network connecting all the mobile gateways.

28. The communication system of claim 25, further comprising a location server on the mobile-gateway-communication network connecting all the mobile gateways.

29. The communication system of claim 25, further comprising:
a plurality of yet other access points configured to transmit and receive signals from mobile nodes implementing the first protocol and the second protocol.

30. The communication system of claim 24, wherein the mobile-gateway-communication network is a dedicated virtual local area network.

31. The communication system of claim 30, further comprising a location server on the virtual local area network connecting all the mobile gateways.

32. The communication system of claim 24, further comprising a location server on the mobile-gateway-communication network connecting all the mobile gateways.

33. The communication system of claim 24, further comprising:
a memory in each mobile gateway to store IP tables, the IP tables including a mapping between blocks of user IP addresses and the mobile gateway to which the user address belongs.

34. A method to enable mobility while connected to an Internet protocol network, comprising:
receiving a first data packet at a mobile gateway via a first access point, wherein the data packet is sent from a mobile node implementing a first protocol;
responsive to receiving the first data packet, sending an inquiry over the mobile-gateway-communication network to determine the mobile gateway is to be used as one of a home mobile gateway and a visited mobile gateway;
when a response to the inquiry is not received from the other mobile gateways in the mobile-gateway-communication network, establishing the mobile gateway as the home mobile gateway; and
when a response to the inquiry is received from one of the other mobile gateways in the mobile-gateway-communication network, establishing the mobile gateway as the visited mobile gateway, wherein the communication session is maintained regardless of the protocol implemented by the mobile node, wherein the home mobile gateway is used for the duration of the communication session, and wherein the visited mobile gateway is used for at least the duration of the communicatively coupling between the first access point and the mobile node.
